(19) United States
(12) Patent Application Publication
(10) Pub. No.: US 2009/0021121 A1
(43) Pub. Date: Jan. 22, 2009

(54) ELECTRICAL MACHINE

(75) Inventors: Karsten Christian, Birkenwerder (DE); Mahmoud-Adel El Falaki, Dallgow-Doberitz (DE); Roland Hauptmann, Berlin (DE); Lutz Hubner, Berlin (DE); Gunter Zwarg, Berlin (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/816,593

(22) PCT Filed: Feb. 8, 2006
(86) PCT No.: PCT/EP06/50740

§ 371 Date: Sep. 12, 2008

(30) Foreign Application Priority Data
Feb. 17, 2005 (DE) 10 2005 007 371.9

(51) Int. Cl. H02K 11/00

(52) U.S. Cl. 310/68 B

(57) ABSTRACT

The invention relates to an electrical machine with a stator and a rotor, the rotor having a winding system (1) and being provided with a measuring/control system (2). Means are also provided which have a voltage tap (14) on the winding system of the rotor and which are used to supply the measuring/control system (2). The advantage of the voltage tap (14) on the winding system (1) is that a separate voltage source on the rotor is not required.

The invention relates to an electrical machine having a stator and a rotor, with the rotor having a measurement/control system and being provided with a winding system.

Electrical machines are used in a very large number of technical fields. Depending on the purpose of the electrical machines, the expressions motor operation (conversion of electrical energy to mechanical) or generator operation (conversion of mechanical energy to electrical) are used. This means that the expression “electrical machine” covers not only motors but also generators. A distinction is also drawn in the case of electrical machines between direct-current machines, single-phase machines and three-phase machines. Three-phase machines can be subdivided into three-phase synchronous machines and three-phase asynchronous machines.

All of these electrical machines contain, inter alia, a stator which does not move and a rotor which is mounted such that it can rotate. The rotor is fitted with a winding system, depending on the type. This winding system may comprise one or more wire windings or bar windings. Squirrel-cage windings can also be constructed from wire windings or else bar windings.

WO 01/17084 and WO 00/67355 disclose electronic components, such as sensors or converters, being fitted to the rotor. However, these documents do not state how these electronic components can be supplied with voltage.

U.S. Pat. No. 6,093,986 proposes that a sensor which is fitted to the rotor be supplied with energy by means of the voltage which is induced in a separately fitted winding system.

However, this has the disadvantage that a separate winding system must be fitted to the rotor, incurring additional costs, and as a result of which the rotor and the housing of the electrical machine have to be made larger.

The invention is therefore based on the object of supplying voltage to a measurement/control system for the rotor, with the aim of minimizing the additional physical complexity. A further aim is to specify a solution such that the measurement/control system can still be operated even when the electrical machine is stationary. By way of example, the measurement/control system may include temperature sensors or a logic circuit which controls emergency shutdown of the electrical machine when a maximum permissible operating temperature is exceeded during operation.

According to the invention, this object is achieved in that means are provided which have a voltage tap on the winding system of the rotor and are used to supply the measurement/control system.

The voltage tap on the winding system advantageously ensures that there is no need to provide any separate voltage source on the rotor. This leads to less physical complexity, to an improvement in robustness and to the costs being minimized, while at the same time improving the operational reliability.

Furthermore, the stated invention can be advantageously applied to a large number of electrical machines. One possibility is for the tapped-off voltage to be produced by induction in the winding system. This is the case, for example, with a three-phase asynchronous machine with a squirrel-cage rotor.

A further possibility is for the winding system to contain field coils, for example in the case of three-phase synchronous machines. The field coils are supplied with current from the exterior. Furthermore, the tapped-off voltage can also be produced by a positive phase-sequence generator system, or can be passed to the rotor through a slipring arrangement.

In all cases, specific contents are provided on the winding system in order to ensure that voltage is tapped off without any faults, even at high rotor rotation speeds.

Further exemplary embodiments result from rectification of the voltage that is induced in the generator system or from using only the alternating component of the voltage which has been tapped off from the winding system to supply the measurement/control system. This can be achieved, for example, by means of a capacitor or a high-pass filter connected downstream from the voltage tap. In this case, a rectifier can be provided, and rectifies the alternating component of the tapped-off voltage.

A further advantage of the invention is to provide a voltage module which transforms the voltage which has been tapped off from the winding system, to be precise the rectified alternating component of the voltage which has been tapped off from the winding system, to a lower voltage interval. This is because it is then possible to use low-cost standard electronic components for the low-voltage area, in order to form the measurement/control system. These standard electronic components may, for example, be logic modules which operate with a fixed supply voltage of, for example, 5V. In order to allow these standard electronic components to be used in the optimum operating range, for example 5V, it is advantageously possible to provide an additional voltage regulator, which regulates the supply voltage for the measurement/control system at a fixed value.

A further advantage of the invention is to provide a rechargeable battery which stores at least a portion of the energy which is produced by tapping off the voltage to supply the measurement/control system. This is because the measurement/control system can then still remain in operation even, for example, when the rotor is not rotating, to be precise when the voltage which has been tapped off from the winding system has fallen below a threshold value. Furthermore, an IC charging processor can be provided for optimum charging of the rechargeable battery. According to the invention, a diode is provided in order to prevent accidental discharging of the rechargeable battery via the winding system.

The invention as well as further advantageous refinements of the invention as claimed in the features of the dependent claims will be explained in more detail in the following text with reference to exemplary embodiments which are illustrated schematically in the drawing, without this implying any restriction of the invention to this exemplary embodiment. In the FIGS.:

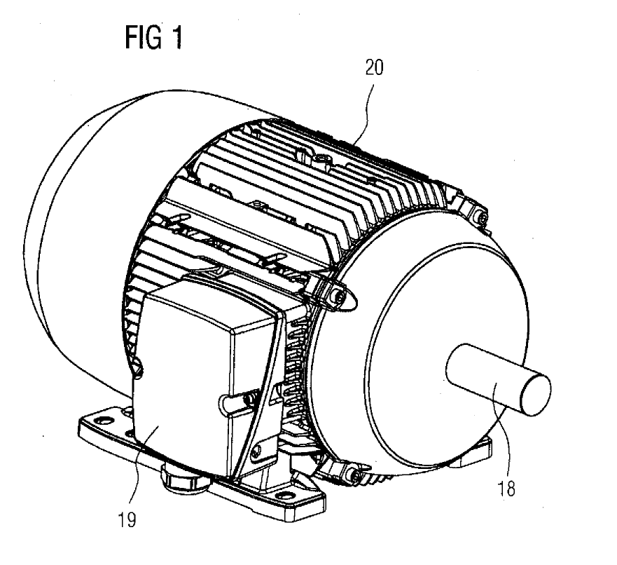

FIG. 1 shows an electrical machine;

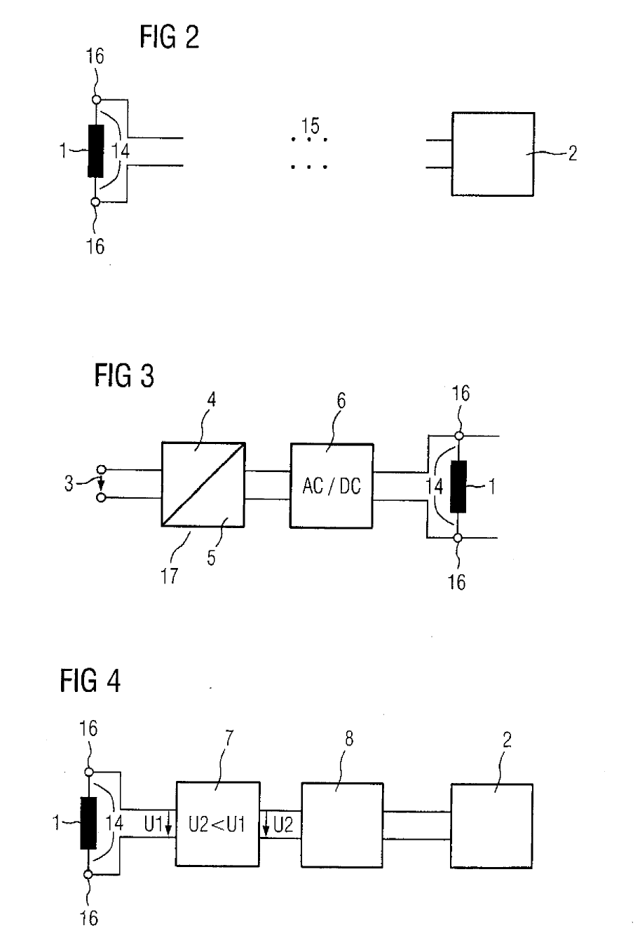

FIG. 2 shows the winding system of the rotor and the measurement/control system;

FIG. 3 shows a design for feeding the winding system with the aid of a generator system;

FIG. 4 shows a circuit for supplying voltage to the measurement/control system;

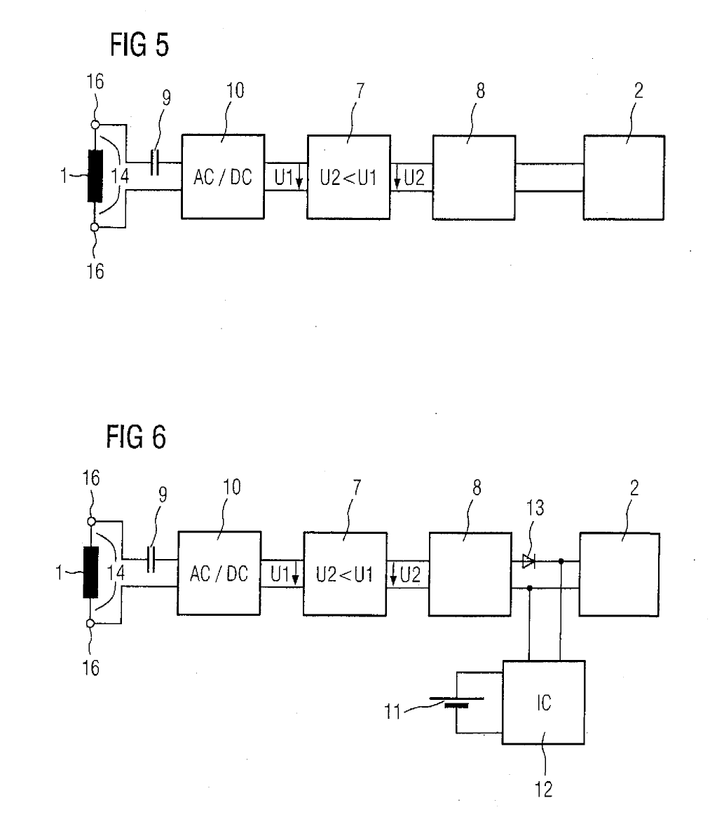

FIG. 5 shows a further circuit for supplying voltage to the measurement/control system; and

FIG. 6 shows a circuit for supplying voltage to the measurement/control system and having a rechargeable battery.

FIG. 1 shows an electrical machine which contains a stator, which does not move, and a rotor which is mounted such that it can rotate. The parts of the electrical machine shown in FIG. 1 are the housing 20, the shaft 18 and the connecting terminal box 19. Depending on the type, the rotor of the electrical machine is fitted with a winding system. This winding system may comprise one or more wire windings or bar windings. Squirrel-cage windings can also be constructed from wire windings or bar windings.

The expression motor operation (conversion of electrical energy to mechanical energy) or generator operation (conversion of mechanical energy to electrical) is used, depending on the purpose of the electrical machine. This means that the expression “electrical machine” covers not only motors but also generators. In the case of electrical machines, a distinction is also drawn between direct-current machines, single-phase machines and three-phase machines. Three-phase machines can be subdivided into three-phase synchronous machines and three-phase asynchronous machines.

FIG. 2 shows an example of a winding system 1 for the rotor, which in this example has two contacts 16, but may also have more than two contacts. FIG. 2 also shows a measurement/control system 2 which is supplied with voltage via a voltage tap 14 on the winding system 1 and a suitable circuit 15. A plurality of voltage taps 14 can also be used to supply voltage to the measurement/control system 2, depending on the number of contacts 16 on the winding system 1. The winding system 1 may include one or more wire or bar windings. Squirrel-cage windings can also be formed from the wire or bar windings, resulting in squirrel-cage rotors. A further possibility is for the winding system 1 to contain field coils, for example in the case of three-phase synchronous machines. The field coils are then supplied with direct current.

In all cases, specific contacts 16 are provided on the winding system 1 in order to preclude faults at the voltage tap 14, even at high rotor rotation speeds. By way of example, these contacts may comprise solder points, or screwed or plug-in connections.

FIG. 3 shows a design for feeding the winding system 1 with the aid of a generator system 17 comprising a voltage source 3, a stator element 4 and a rotor element 5. A rectifier 6 is used to rectify the voltage induced in the rotor element 5 of the generator system 17. The rotor element 5 of the generator system 17 is located on the same shaft as the winding system 1. The voltage induced in the rotor element 5 in the generator system 17 can be influenced by the voltage source 3. The rectified voltage then drives a current through the winding system 1.

FIG. 4 shows one exemplary embodiment for the circuit 15. The voltage which is tapped off from the contacts 16 on the winding system 1 with the aid of the voltage tap 14 is transformed by a voltage module 7 to a lower voltage, since the tapped-off voltage may in some circumstances be very high. The transformed voltage is then regulated by a voltage regulator 8 at a constant output voltage in order to supply the measurement/control system 2. The voltage module 7 can also be used to separate the potentials of the winding system 1 and of the voltage regulator 8.

FIG. 5 shows a further circuit 15 for supplying voltage to the measurement/control system 2. In contrast to the exemplary embodiment shown in FIG. 4, only the alternating component of the voltage which has been tapped off by the voltage tap 14 is used to supply the measurement/control system 2. The alternating component is tapped off with the aid of a capacitor 2 or a high-pass filter. The tapped-off alternating voltage is then rectified by a rectifier 10. The voltage that results from this is then transformed again by the voltage module 7 and is regulated by the voltage regulator 8 at a fixed voltage, which is then used to supply voltage to the measurement/control system 2.

FIG. 6 shows a circuit for supplying voltage to the measurement/control system 2 and having a rechargeable battery 11. The rechargeable battery 11 means that the measurement/control system 2 can still be operated even when, for example, the rotor is not rotating, to be precise the voltage which has been tapped off from the winding system 1 has fallen below a threshold value. An IC charging processor 12 can also be provided for optimum charging of the rechargeable battery 11. A diode 13 can be provided in order to prevent accidental discharge of the rechargeable battery 11, for example via the winding system 1.

1.-14. (canceled)

15. An electrical machine, comprising:
a stator;
a rotor constructed in the form of a squirrel-cage rotor and having a winding system, said rotor being provided with a measurement/control system; and
a voltage tap disposed on the winding system of the rotor for supplying electric power to the measurement/control system.

16. The electrical machine of claim 15, wherein the winding system has a voltage tap.

17. The electrical machine of claim 15, further comprising a filter which allows only an alternating component of the voltage generated at the voltage tap to pass to supply electric power to the measurement/control system.

18. The electrical machine of claim 17, wherein the filter comprises a capacitor.

19. The electrical machine of claim 17, wherein the filter is implemented as a high-pass filter.

20. The electrical machine of claim 17, further comprising a rectifier to rectify the alternating component of the voltage.

21. The electrical machine of claim 15, further comprising a voltage module which receives the voltage from the voltage tap and transforms the received voltage to a lower voltage.

22. The electrical machine of claim 21, further comprising a voltage regulator receiving the lower voltage from the voltage module.

23. The electrical machine of claim 21, wherein the voltage module is configured to provide galvanic separation between potentials of the winding system and of the voltage regulator.

24. The electrical machine of claim 15, further comprising a rechargeable battery which stores at least a portion of electric energy supplied at the voltage tap.

25. The electrical machine of claim 24, further comprising a charging processor implemented as an integrated circuit (IC) for charging the rechargeable battery.

26. The electrical machine of claim 24, further comprising a diode to prevent the rechargeable battery from being discharged via the winding system.
